(19) United States
(12) Patent Application Publication
(10) Pub. No.: US 2025/0215297 A1
(43) Pub. Date: Jul. 3, 2025

(54) REFRIGERATION CYCLE APPARATUS

(71) Applicant: Mitsubishi Electric Corporation, Tokyo (JP)

(72) Inventors: Yusuke TASHIRO, Tokyo (JP); Kenta MURATA, Tokyo (JP); Takuya MATSUDA, Tokyo (JP); Hideaki MAEYAMA, Tokyo (JP)

(21) Appl. No.: 18/846,862

(22) PCT Filed: Mar. 25, 2022
(86) PCT No.: PCT/JP2022/014638

§ 371 Date: Sep. 13, 2024

(51) Int. Cl. C09K 5/04

(52) U.S. Cl. CPC C09K 5/045; C09K 2205/126; C09K 2205/22

(57) ABSTRACT

A refrigeration cycle apparatus includes a refrigeration circuit including a compressor, an outdoor heat exchanger, an indoor heat exchanger, and an expansion valve, refrigerant is enclosed in the refrigeration circuit, the refrigerant contains three components R1234yf, HFO1123, and R290, a composition diagram is represented by triangular coordinates includes: a point A representing R1234yf/HFO1123/R290=100/0/0% by mass, a point B representing R1234yf/HFO1123/R290=85/0/15% by mass, a point C representing R1234yf/HFO1123/R290=20/80/0% by mass, and a point D representing R1234yf/HFO1123/R290=6.2/78.8/15% by mass, the mass ratio between the three components falls in a first range enclosed by a straight line 1 connecting the point A to the point B, a straight line 2 connecting the point A to the point C, a straight line 3 connecting the point B to the point D, and a curve 1 connecting the point C to the point D.

### CROSS-REFERENCE TO RELATED APPLICATION

This application is a U.S. National Stage Application of International Application No. PCT/JP2022/014638 filed Mar. 25, 2022, the contents of which are incorporated herein by reference.

### TECHNICAL FIELD

The present disclosure relates to a refrigeration cycle apparatus.

### BACKGROUND

For refrigeration cycle apparatuses such as air conditioner and refrigerator, refrigerants such as chlorofluorocarbon (CFC) and hydrochlorofluorocarbon (HCFC) have been used. Refrigerants containing chlorine such as CFC and HCFC, however, are currently restricted in use, because they have a significant influence on the ozone layer in the stratosphere (influence on global warming).

Therefore, hydrofluorocarbon (HFC) that is chlorine free and has a smaller influence on the ozone layer has become used as refrigerant. An example of such HFC is difluoromethane (hereinafter referred to as “R32”).

However, it has been indicated that R32 having a global warming potential (GWP) of 675 could be a cause of global warming. There is thus a demand for development of refrigerant having a lower GWP and a smaller influence on the ozone layer.

1,1,2-trifluoroethylene (hereinafter referred to as “HFO1123”) having a GWP of about 0.3 is known as refrigerant having a smaller influence on global warming and enabling a refrigeration cycle apparatus to exhibit sufficient cycling performance. HFO1123, however, is prone to disproportionation reaction under high temperature and high pressure conditions. Accordingly, refrigerant containing HFO1123 and capable of suppressing disproportionation reaction has been studied (PTL 1, for example).

### PATENT LITERATURE

PTL 1: WO2021/075075

The refrigerant used in PTL 1 contains R32 and R744 (carbon dioxide) together with HFO1123 to suppress disproportionation reaction of HFO1123. R744, however, has a higher condensing pressure than R32 which has been used. In an existing refrigeration cycle apparatus in which R32 is used as refrigerant, if the refrigerant is replaced with refrigerant containing R744, a higher condensing pressure will be generated. While the existing refrigeration cycle apparatus has pressure resistance to the pressure around the condensing pressure of R32, it may not have pressure resistance to a pressure higher than the condensing pressure of R32. In consideration of the need to ensure the reliability of the refrigeration cycle apparatus, particularly in terms of the pressure resistance, it should be difficult for the refrigerant of PTL 1 to replace the refrigerant for the existing refrigeration cycle apparatus in which the conventional refrigerant (R32, for example) has been used.

Meanwhile, for reduction of the cost, there is a demand for refrigerant that can replace the refrigerant in the existing refrigeration cycle apparatus, i.e., a demand for refrigerant that can be retrofit into the existing refrigeration cycle apparatus.

### SUMMARY

An object of the present disclosure is to provide a refrigeration cycle apparatus that has a smaller influence on global warming and can also be manufactured from an existing refrigeration cycle apparatus for which conventional refrigerant (R32, for example) is used, by replacing the refrigerant of the existing refrigeration cycle apparatus.

A refrigeration cycle apparatus of the present disclosure is
a refrigeration cycle apparatus including a refrigeration circuit, the refrigeration circuit including a compressor, an outdoor heat exchanger, an indoor heat exchanger, and an expansion valve, wherein
refrigerant is enclosed in the refrigeration circuit,
the refrigerant contains three components that are R1234yf, HFO1123, and R290,
a composition diagram in which a mass ratio between the three components is represented by triangular coordinates includes
   a point A representing 100% by mass of R1234yf, 0% by mass of HFO1123, and 0% by mass of R290,
   a point B representing 85% by mass of R1234yf, 0% by mass of HFO1123, and 15% by mass of R290,
   a point C representing 20% by mass of R1234yf, 80% by mass of HFO1123, and 0% by mass of R290, and
   a point D representing 6.2% by mass of R1234yf, 78.8% by mass of HFO1123, and 15% by mass of R290,
the mass ratio between the three components falls in a first range enclosed by
   a straight line 1 connecting the point A to the point B,
   a straight line 2 connecting the point A to the point C,
   a straight line 3 connecting the point B to the point D, and
   a curve 1 connecting the point C to the point D, and
each of the three components has a mass ratio of more than 0% by mass.

According to the present disclosure, a refrigeration cycle apparatus can be provided that has a smaller influence on global warming and can also be manufactured from an existing refrigeration cycle apparatus for which conventional refrigerant (R32, for example) is used, by replacing the refrigerant of the existing refrigeration cycle apparatus.

### BRIEF DESCRIPTION OF DRAWINGS

FIG. 1 is a schematic configuration diagram showing a refrigeration cycle apparatus according to Embodiment 1.

FIG. 2 is a ternary composition diagram showing a range of the mass ratio of refrigerant according to Embodiment 1.

FIG. 3 is a ternary composition diagram showing a preferred range of the mass ratio of refrigerant according to Embodiment 1.

FIG. 4 is a ternary composition diagram showing a more preferred range of the mass ratio of refrigerant according to Embodiment 1.

### DETAILED DESCRIPTION

In the following, embodiments of the present disclosure are described based on the drawings.

### Embodiment 1

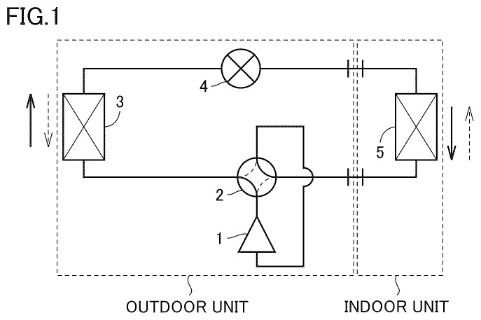

First, an overview of a refrigeration cycle apparatus in the present embodiment is described briefly. FIG. 1 is a schematic configuration diagram showing the refrigeration cycle apparatus according to Embodiment 1. The refrigeration cycle apparatus includes a refrigeration circuit, and the refrigeration circuit includes a compressor 1, a flow path switching valve 2 to switch the flow direction depending on whether the apparatus works for cooling or heating, an outdoor heat exchanger 3, an expansion valve 4, and an indoor heat exchanger 5. For a refrigeration cycle apparatus that is not required to switch between cooling and heating, flow path switching valve 2 is unnecessary.

For cooling, gaseous refrigerant of high temperature and high pressure generated through compression by compressor 1 flows through flow path switching valve 2 (the flow path indicated by the solid line) into outdoor heat exchanger 3 to be condensed at outdoor heat exchanger 3. The liquid refrigerant generated through condensation at outdoor heat exchanger 3 flows through expansion valve 4 into indoor heat exchanger 5 to be evaporated (vaporized) at indoor heat exchanger 5. Finally, the gaseous refrigerant generated through evaporation at indoor heat exchanger 5 returns to compressor 1 through flow path switching valve 2 (the flow path indicated by the solid line). In this way, for cooling, refrigerant circulates in the refrigeration circuit of the refrigeration cycle apparatus in the direction indicated by solid-line arrows shown in FIG. 1.

For heating, gaseous refrigerant of high temperature and high pressure generated through compression by compressor 1 flows through flow path switching valve 2 (the flow path indicated by the dotted line) into indoor heat exchanger 5 to be condensed at indoor heat exchanger 5. The liquid refrigerant generated through condensation at indoor heat exchanger 5 flows through expansion valve 4 into outdoor heat exchanger 3 to be evaporated (vaporized) at outdoor heat exchanger 3. The refrigerant vaporized at outdoor heat exchanger 3 returns to compressor 1 through flow path switching valve 2 (the flow path indicated by the dotted line). In this way, for heating, refrigerant circulates in the refrigeration circuit of the refrigeration cycle apparatus in the direction indicated by broken-line arrows shown in FIG. 1.

The above-described elements of the configuration are minimum required elements of the refrigeration cycle apparatus capable of cooling and heating. The refrigeration cycle apparatus in the present embodiment may further include other devices such as gas-liquid separator, receiver, accumulator, high and low pressure heat exchanger.

### <Refrigerant>

Initially, for better understanding of the present disclosure, Table 1 shows respective numerical values of physical properties (pressure, density, specific heat at constant pressure, densityxspecific heat) of single refrigerants R32, R290, R1234yf (2,3,3,3-tetrafluoro-1-propene), HFO1123, and R744 (carbon dioxide) when sucked. These numerical values of the physical properties are those under the conditions that the suction saturation temperature is 10° C. and the suction SH (suction temperature-suction saturation temperature) is 1 K. In Table 1, the numerical values [%] in the cells for “density,” “specific heat at constant pressure” and “densityxspecific heat” are respective percentages of the density, the specific heat at constant pressure, and densityxspecific heat of each refrigerant, with respect to the density, the specific heat at constant pressure, and densityxspecific heat of R32 that are defined as 100%.

TABLE 1

| type of refrigerant | | R32 | R290 | R1234yf | HFO1123 | R744 |
|---|---|---|---|---|---|---|
| pressure | [MPaA] | 1.107 | 0.637 | 0.438 | 1.439 | 4.502 |
| density | [kg/m³] | 30.0 | 13.7 | 24.1 | 65.3 | 132.7 |
| | [%] | 100.00 | 45.68 | 80.43 | 217.63 | 442.30 |
| specific heat at | [kJ/kgK] | 1.346 | 1.835 | 0.971 | 1.167 | 2.411 |
| constant pressure | [%] | 100.00 | 136.32 | 72.17 | 86.72 | 179.10 |
| density × specific | [%] | 100.00 | 62.27 | 58.04 | 188.73 | 792.17 |
| heat | | | | | | |

The higher the pressure of the single refrigerant, the higher the condensing pressure. R744 is higher in pressure than R32 and therefore also higher in condensing pressure than R32.

Refrigerant enclosed in the refrigeration circuit in the present embodiment is described. The refrigerant contains three components that are R1234yf (2,3,3,3-tetrafluoro-1-propene), HFO1123 (1,1,2-trifluoroethylene), and R290 (propane) that fall in a predetermined composition range.

In the present disclosure, the mass ratio of each of R1234yf, HFO1123 and R290 in the refrigerant refers to the mass ratio of each of R1234yf, HFO1123 and R290 in the refrigerant before the refrigeration cycle apparatus including the refrigeration circuit is actuated. The mass ratio of each of R1234yf, HFO1123 and R290 is regarded as being the same as the mass ratio of each of R1234yf, HFO1123 and R290 in the refrigerant before enclosed in the refrigeration circuit. Specifically, the mass ratio of each of R1234yf, HFO1123 and R290 in the refrigerant in a refrigerant cylinder filled with the refrigerant to be enclosed in the refrigeration circuit is regarded as being the same as the mass ratio of each of R1234yf, HFO1123 and R290 in the refrigerant having been enclosed in the refrigeration circuit.

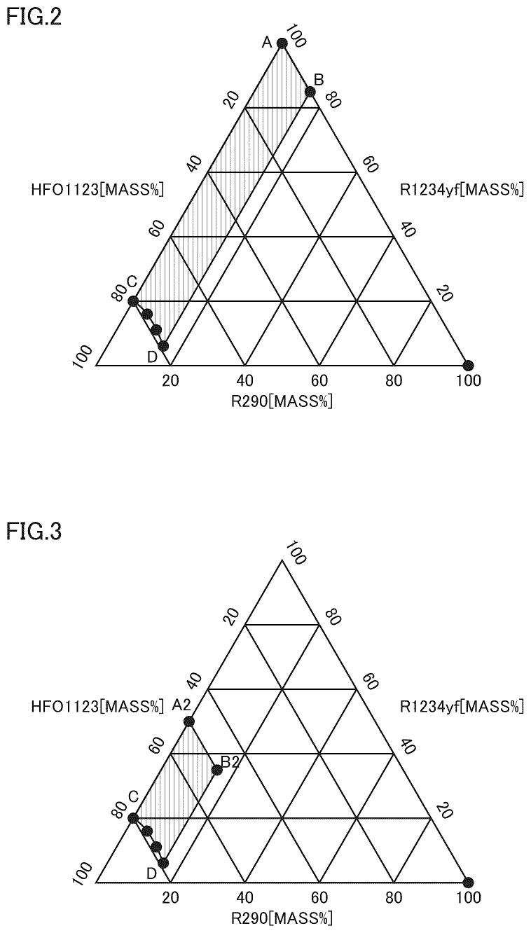

FIG. 2 is a composition diagram (ternary composition diagram) showing, by triangular coordinates, the mass ratio (composition ratio) between the three components (R1234yf, HFO1123, and R290) contained in the refrigerant. In FIG. 2, the mass ratio between the three components falls in a first range (the hatched portion in FIG. 2) enclosed by a straight line 1 connecting a point A to a point B, a straight line 2 connecting the point A to a point C, a straight line 3 connecting the point B to a point D, and a curve 1 connecting the point C to the point D. The first range does not include a ratio where the ratio of at least one of the three components is 0% by mass. In other words, the mass ratio of each of the three components is higher than 0% by mass.

The point A represents 100% by mass of R1234yf, 0% by mass of HFO1123, and 0% by mass of R290. Such mass ratio is hereinafter represented as “R1234yf/HFO1123/R290=100/0/0% by mass.”

The point B represents the mass ratio “R1234yf/HFO1123/R290=85/0/15% by mass.”

The point C represents the mass ratio “R1234yf/HFO1123/R290=20/80/0% by mass.”

The point D represents the mass ratio “R1234yf/HFO1123/R290=6.2/78.8/15% by mass.”

In FIG. 2, the curve 1 connecting the point C to the point D is represented by a formula (1):

$$Y = 0.014 {X}^{2} - 0.250 X + 79.4 \qquad ( 1 )$$

where X [%] is a mass ratio of R290 and Y [%] is a mass ratio of HFO1123 in a coordinate system having an X axis representing the mass ratio of the component R290 and a Y axis perpendicular to the X axis.

A mass ratio Z [%] of R1234yf is represented by a formula (2):

$$Z = 100 - X - Y . \qquad ( 2 )$$

The curve 1 is a line (boundary line) representing the composition where the condensing pressure is equal to that of R32.

In FIG. 2, in the range of the mass ratio on the upper right side of the curve 1 connecting the point C to the point D, the refrigerant has a condensing pressure of less than or equal to the condensing pressure of R32. Therefore, the refrigerant having a mass ratio in this range can replace R32 in an existing refrigeration cycle apparatus in which R32 is used as refrigerant, and still maintain the reliability of the refrigeration apparatus in terms of the pressure resistance, without requiring change of the specification of the pressure resistance of the refrigeration apparatus.

R1234yf, HFO1123, and R290 all have a low GWP. Specifically, R1234yf has a GWP of 1, HFO1123 has a GWP of about 0.3, and R290 has a GWP of 6. In the present embodiment, the refrigerant contains these three components, so that the refrigerant has a low GWP and a refrigeration cycle apparatus for which this refrigerant is used has a small influence on global warming.

While R290 is flammable, the mass ratio of the refrigerant in the present embodiment falls in the first range indicated by the hatching in FIG. 2 and the ratio of R290 in the refrigerant is a low ratio of 15% by mass or less. Further, R1234yf is a refrigerant having mild flammability classified in the A2L group by the flammability classification under the ASHRAE34 standard, and therefore, the flammability of the whole refrigerant can be kept low. Thus, the flammability of the refrigerant in the present embodiment is less than or equal to the flammability of R32. The flammability of R32 is classified in the A2L group by the flammability classification under the ASHRAE34 standard.

HFO1123 is prone to disproportionation reaction under high temperature and high pressure conditions. R1234yf and R290 can suppress the disproportionation reaction of HFO1123. In the present embodiment, the refrigerant contains R1234yf and R290 together with HFO1123. Therefore, this refrigerant can suppress the disproportionation reaction of HFO1123.

The effect of suppressing the disproportionation reaction of HFO1123 by R290 can be explained in terms of change of chemical reaction when the disproportionation reaction occurs. It is known that HFO1123 causes disproportionation reaction specified by the following formula (A).

CF₂=CHF→1.5C+0.5CF₄+HF+250 KJ/mol (A)

If the ratio of R290 to HFO1123 in their mixture is low, the chemical reaction specified by the following formula (B) is dominant.

C₃H₈+2CF₄=8HF+5C[gr]+212 kJ/mol (B)

The chemical reaction specified by the formula (B) generates large reaction heat and is likely to induce new reaction propagation, and therefore has a smaller effect of suppressing the disproportionation reaction of HFO1123.

If the ratio of R290 in the mixture is higher, the chemical reaction specified by the following formula (C) is dominant.

C₃H₈=2CH₄+C[gr]+45 KJ/mol (C)

The chemical reaction specified by the formula (C) generates smaller reaction heat and smaller energy for causing new reaction propagation, and therefore has a larger effect of suppressing the disproportionation reaction of HFO1123.

It is presumed that which of the chemical reactions of the formula (B) and the formula (C) is dominant is influenced by the ratio of hydrogen (H) and fluorine (F) contained in the refrigerant. In the refrigerant of the present embodiment, the ratio of H/F is higher than 1, and it is therefore presumed that the dominant chemical reaction is likely to change from the formula (B) to the formula (C), and accordingly, the effect of lowering the temperature generated during the disproportionation reaction and suppressing propagation of the disproportionation reaction is improved.

It is presumed that the effect of suppressing the disproportionation reaction of HFO1123 by R1234yf is produced from reduction of the concentration of HFO1123 by dilution.

As seen from the foregoing, the refrigerant in the present embodiment has flammability lower than or equal to that of R32, and can suppress the disproportionation reaction of HFO1123. Thus, the refrigerant of the present embodiment can keep the reliability, in terms of safety, of the refrigeration cycle apparatus, without requiring change of the specification of devices and control of the refrigeration cycle apparatus (safety specification) even when the refrigerant replaces R32 in an existing refrigeration cycle apparatus in which R32 is used as refrigerant.

HFO1123 has a high operating pressure and the refrigerant has a low volume flow rate, and therefore, the pressure loss is small and adequate performance can easily be ensured. R1234yf exhibits high theoretical performance. In the present embodiment, the refrigerant contains HFO1123 and R1234yf, and can therefore exhibit high performance higher than or equivalent to that of R32. Accordingly, this refrigerant, even when it replaces R32 in an existing refrigeration cycle apparatus in which R32 is used as refrigerant, can maintain adequate performance of the refrigeration cycle apparatus, without requiring change of the cycle specification of the refrigeration cycle apparatus.

It is seen from the foregoing that the refrigeration cycle apparatus of the present embodiment has a smaller influence on global warming, and can also be manufactured from an existing refrigeration cycle apparatus for which conventional refrigerant (R32, for example) is used, by replacing the refrigerant of the existing refrigeration cycle apparatus. Further, it is seen that this refrigeration cycle apparatus exhibits high performance. The refrigeration cycle apparatus of the present embodiment may be manufactured by any method other than the method that replaces the refrigerant in an existing refrigeration cycle apparatus. The refrigeration cycle apparatus of the present embodiment may be a refrigeration cycle apparatus that is newly manufactured.

A preferred mass ratio of the refrigerant in the present embodiment is described with reference to FIG. 3. FIG. 3 is a ternary composition diagram showing a preferred range of the mass ratio (composition ratio) between three components (R1234yf, HFO1123, and R290) contained in the refrigerant. In FIG. 3, the mass ratio between the three components falls in a second range (the hatched portion in FIG. 3) enclosed by a straight line 2-1 connecting a point A2 to a point B2, a straight line 2-2 connecting the point A2 to the point C, a straight line 2-3 connecting the point B2 to the point D, and the curve 1. The second range does not include a ratio where the ratio of at least one of the three components is 0% by mass. In other words, the mass ratio of each of the three components is higher than 0% by mass.

The point A2 represents 50% by mass of R1234yf, 50% by mass of HFO1123, and 0% by mass of R290.

The point B2 represents 35% by mass of R1234yf, 50% by mass of HFO1123, and 15% by mass of R290.

The point C and the point D represent the same mass ratios as those of the point C and the point D on FIG. 2, respectively.

In the second range of FIG. 3, HFO1123 in the refrigerant has a high ratio of 50% by mass or more. Accordingly, the refrigerant can have a lower GWP, can be prevented from being reduced in operating pressure, and can exhibit higher performance. The refrigeration cycle apparatus in which this refrigerant is used can thus have a smaller influence on global warming and exhibit still higher performance.

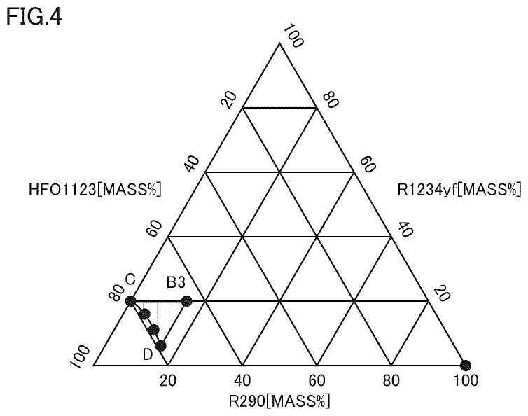

A more preferred mass ratio of the refrigerant in the present embodiment is described with reference to FIG. 4. FIG. 4 is a ternary composition diagram showing a more preferred range of the mass ratio (composition ratio) between three components (R1234yf, HFO1123, and R290) contained in the refrigerant. In FIG. 4, the mass ratio between the three components falls in a third range (the hatched portion in FIG. 4) enclosed by a straight line 3-1 connecting a point B3 to the point C, a straight line 3-2 connecting the point B3 to the point D, and the curve 1. The third range does not include a ratio where the ratio of at least one of the three components is 0% by mass. In other words, the mass ratio of each of the three components is higher than 0% by mass.

The point B3 represents 20% by mass of R1234yf, 65% by mass of HFO1123, and 15% by mass of R290.

The point C and the point D represent the same mass ratios as those of the point C and the point D on FIG. 2, respectively.

In the third range of FIG. 4, R1234yf in the refrigerant has a ratio of 20% by mass or less. Accordingly, the refrigerant can have a still lower GWP, can be prevented from being reduced in operating pressure, and can exhibit still higher performance. The refrigeration cycle apparatus in which this refrigerant is used can thus have a still smaller influence on global warming and exhibit still higher performance.

In the refrigerant, a content C2 by mass of R290 to a content C1 by mass of HFO1123, in percentage, namely (C2/C1)×100, is preferably 15% or more and less than 50%. R290, even at a lower content, has a high effect of suppressing disproportionation reaction of HFO1123. Therefore, as long as the percentage (C2/C1)×100 is 15% or more, a high effect of suppressing disproportionation reaction of HFO1123 can be obtained. Moreover, as long as the percentage (C2/C1)×100 is less than 50%, the content of HFO1123 in the refrigerant can be increased. Accordingly, the refrigerant can have a lower GWP and exhibit high cycling performance.

The refrigerant used in the present embodiment may consist of the above-described three components only. Alternatively, the refrigerant may contain additional component(s). The ratio of the additional component(s) is set to fall in a range that does not hinder the principal effects of the present embodiment. For example, the total content of the three components in the refrigerant can be set to a content of 90% by mass or more and 100% by mass or less.

The refrigerant used in the present embodiment may further contain refrigerator oil. The refrigerator oil may for example be a commonly-used refrigerator oil (such as ester-based lubricating oil, ether-based lubricating oil, fluorine-based lubricating oil, mineral-based lubricating oil, hydrocarbon-based lubricating oil). In this case, preferably a refrigerator oil excellent in stability for example is selected.

The refrigerant used in the present embodiment may further contain a stabilizer as required, in the case for example where high stability is required under harsh conditions in use, for example. The stabilizer is a component for improving the stability of refrigerant against heat and oxidation. The stabilizer may for example be any known stabilizer used conventionally for refrigeration cycle apparatuses, such as oxidation resistance improving agent, heat resistance improving agent, metal deactivator, or the like.

The refrigerant used in the present embodiment may further contain a polymerization inhibitor. The polymerization inhibitor may for example be any of hydroquinone, hydroquinone methyl ether, benzotriazole, and the like.

### <Refrigeration Cycle Apparatus>

The refrigeration cycle apparatus in the present embodiment is preferably a refrigeration cycle apparatus for air conditioning (air conditioner). R32 is a refrigerant having been used chiefly for the air conditioner, and the refrigerant used for the refrigeration cycle apparatus of the present embodiment has a lower condensing pressure than the condensing pressure of R32. Therefore, particularly for the refrigeration cycle apparatus applied to air conditioning, the reliability in terms of the pressure resistance can be maintained.

The refrigeration cycle apparatus for air conditioning (air conditioner) may for example be any of a room air conditioner, a window-type air conditioner, a mobile air conditioner, a package air conditioner, a multi air conditioner for building, and the like.

### <Refrigerator Oil>

In the present embodiment, compressor 1 may be charged with refrigerator oil. Either refrigerator oil having high compatibility with the refrigerant or refrigerator oil having low compatibility with the refrigerant can be used as the refrigerator oil.

### Embodiment 2

In Embodiment 1, the refrigerant contains the three components: R1234yf (2,3,3,3-tetrafluoro-1-propene), HFO1123 (1,1,2-trifluoroethylene), and R290 (propane) that fall in a predetermined composition range. Embodiment 2 uses the refrigerant of Embodiment 1 in which R290 is replaced with at least one compound selected from the group consisting of hydrocarbon having a carbon number of 1 or more and 5 or less, and a fluorinated hydrocarbon having a carbon number of 1 or more and 5 or less. Thus, a refrigeration cycle apparatus can be provided that has a smaller influence on global warming and can also be manufactured from an existing refrigeration cycle apparatus for which conventional refrigerant (R32, for example) is used, by replacing the refrigerant of the existing refrigeration cycle apparatus.

The above-descried compound may for example be any of methane (CH₄), ethane (C₂H₆), butane (C₄H₁₀), isobutane (iso-C₄H₁₀), propylene (C₃H₆), fluoromethane (CH₃F, R41), fluoroethane (C₂H₅F, R161), and 1,1-difluoroethane (C₂H₄F₂, R152a).

### [Appendix 1]

A refrigeration cycle apparatus according to one embodiment of the present disclosure includes a refrigeration circuit, and the refrigeration circuit includes a compressor, an outdoor heat exchanger, an indoor heat exchanger, and an expansion valve,
refrigerant is enclosed in the refrigeration circuit,
the refrigerant contains three components that are R1234yf, HFO1123, and butane,
a composition diagram in which a mass ratio between the three components is represented by triangular coordinates includes
   a point A representing 100% by mass of R1234yf, 0% by mass of HFO1123, and 0% by mass of butane,
   a point B representing 85% by mass of R1234yf, 0% by mass of HFO1123, and 15% by mass of butane,
   a point C representing 20% by mass of R1234yf, 80% by mass of HFO1123, and 0% by mass of butane, and
   a point D representing 6.2% by mass of R1234yf, 78.8% by mass of HFO1123, and 15% by mass of butane,
the mass ratio between the three components falls in a first range enclosed by
   a straight line 1 connecting the point A to the point B,
   a straight line 2 connecting the point A to the point C,
   a straight line 3 connecting the point B to the point D, and
   a curve 1 connecting the point C to the point D, and each of the three components has a mass ratio of more than 0% by mass.

### [Appendix 2]

A refrigeration cycle apparatus according to one embodiment of the present disclosure includes a refrigeration circuit, and the refrigeration circuit includes a compressor, an outdoor heat exchanger, an indoor heat exchanger, and an expansion valve,
refrigerant is enclosed in the refrigeration circuit,
the refrigerant contains three components that are R1234yf, HFO1123, and isobutane,
a composition diagram in which a mass ratio between the three components is represented by triangular coordinates includes
   a point A representing 100% by mass of R1234yf, 0% by mass of HFO1123, and 0% by mass of isobutane,
   a point B representing 85% by mass of R1234yf, 0% by mass of HFO1123, and 15% by mass of isobutane,
   a point C representing 20% by mass of R1234yf, 80% by mass of HFO1123, and 0% by mass of isobutane, and
   a point D representing 6.2% by mass of R1234yf, 78.8% by mass of HFO1123, and 15% by mass of isobutane,
the mass ratio between the three components falls in a first range enclosed by
   a straight line 1 connecting the point A to the point B,
   a straight line 2 connecting the point A to the point C,
   a straight line 3 connecting the point B to the point D, and
   a curve 1 connecting the point C to the point D, and
each of the three components has a mass ratio of more than 0% by mass.

It should be construed that the embodiments and examples disclosed herein are given by way of illustration in all respects, not by way of limitation. It is intended that the scope of the present disclosure is defined by claims, not by the description above, and encompasses all modifications and variations equivalent in meaning and scope to the claims.

1. A refrigeration cycle apparatus comprising a refrigeration circuit, the refrigeration circuit comprising a compressor, an outdoor heat exchanger, an indoor heat exchanger, and an expansion valve, wherein
refrigerant is enclosed in the refrigeration circuit,
the refrigerant contains three components that are R1234yf, HFO1123, and R290,
a composition diagram in which a mass ratio between the three components is represented by triangular coordinates includes
a point A representing 100% by mass of R1234yf, 0% by mass of HFO1123, and 0% by mass of R290,
a point B representing 85% by mass of R1234yf, 0% by mass of HFO1123, and 15% by mass of R290,
a point C representing 20% by mass of R1234yf, 80% by mass of HFO1123, and 0% by mass of R290, and
a point D representing 6.2% by mass of R1234yf, 78.8% by mass of HFO1123, and 15% by mass of R290,
the mass ratio between the three components falls in a first range enclosed by
a straight line 1 connecting the point A to the point B,
a straight line 2 connecting the point A to the point C,
a straight line 3 connecting the point B to the point D, and
a curve 1 connecting the point C to the point D, and each of the three components has a mass ratio of more than 0% by mass.

2. The refrigeration cycle apparatus according to claim 1, wherein
the curve 1 is represented by a formula (1):
$$Y = 0.014 {X}^{2} - 0.250 X + 79.4 \qquad ( 1 )$$
where X [%] is a mass ratio of R290 and Y [%] is a mass ratio of HFO1123, in a coordinate system having an X axis representing the mass ratio of the component R290 and a Y axis perpendicular to the X axis, and
a mass ratio Z [%] of R1234yf is represented by a formula (2):
$$Z = 100 - X - Y . \qquad ( 2 )$$

3. The refrigeration cycle apparatus according to claim 1, wherein
the composition diagram includes
a point A2 representing 50% by mass of R1234yf, 50% by mass of HFO1123, and 0% by mass of R290, and
a point B2 representing 35% by mass of R1234yf, 50% by mass of HFO1123, and 15% by mass of R290, and
the mass ratio between the three components falls in a second range enclosed by
a straight line 2-1 connecting the point A2 to the point B2,
a straight line 2-2 connecting the point A2 to the point C,
a straight line 2-3 connecting the point B2 to the point D, and
the curve 1.

4. (canceled)

5. The refrigeration cycle apparatus according to claim 2, wherein
the composition diagram includes
a point A2 representing 50% by mass of R1234yf, 50% by mass of HFO1123, and 0% by mass of R290, and
a point B2 representing 35% by mass of R1234yf, 50% by mass of HFO1123, and 15% by mass of R290, and
the mass ratio between the three components falls in a second range enclosed by
a straight line 2-1 connecting the point A2 to the point B2,
a straight line 2-2 connecting the point A2 to the point C,
a straight line 2-3 connecting the point B2 to the point D, and
the curve 1.

6. The refrigeration cycle apparatus according to claim 1, wherein
the composition diagram includes a point B3 representing 20% by mass of R1234yf, 65% by mass of HFO1123, and 15% by mass of R290, and
the mass ratio between the three components falls in a third range enclosed by
a straight line 3-1 connecting the point B3 to the point C,
a straight line 3-2 connecting the point B3 to the point D, and
the curve 1.

7. The refrigeration cycle apparatus according to claim 2, wherein
the composition diagram includes a point B3 representing 20% by mass of R1234yf, 65% by mass of HFO1123, and 15% by mass of R290, and
the mass ratio between the three components falls in a third range enclosed by
a straight line 3-1 connecting the point B3 to the point C,
a straight line 3-2 connecting the point B3 to the point D, and
the curve 1.

8. The refrigeration cycle apparatus according to claim 3, wherein
the composition diagram includes a point B3 representing 20% by mass of R1234yf, 65% by mass of HFO1123, and 15% by mass of R290, and
the mass ratio between the three components falls in a third range enclosed by
a straight line 3-1 connecting the point B3 to the point C,
a straight line 3-2 connecting the point B3 to the point D, and
the curve 1.
